(19) United States
(12) Patent Application Publication
(10) Pub. No.: US 2009/0270064 A1
(43) Pub. Date: Oct. 29, 2009

(54) METHOD AND SYSTEM ARCHITECTURE FOR ESTABLISHING A SPECIFIC COMMUNICATION SESSION IN A COMMUNICATION NETWORK

(75) Inventors: Srisankar S. Kunniyur, Bangalore (IN); Irfan Ali, Northbrook, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/160,262

(22) PCT Filed: Jan. 4, 2007
(86) PCT No.: PCT/US07/60092

§ 371 Date: Mar. 16, 2009

(30) Foreign Application Priority Data
Jan. 9, 2006 (IN) 72/DEL/2006

(51) Int. Cl. H04M 11/04; H04W 4/00

(52) U.S. Cl. 455/404.1; 455/435.1

(57) ABSTRACT

A method and network architecture for establishing a specific communication session between a user equipment (UE) (102) and a called entity (106) in a communication network (100) is disclosed. The communication network includes a home overlay network (110) and a visitor overlay network (112). The method includes registering the UE through a home-network entity (114) during registration of the UE with the home overlay network. The method further includes sending an indication message to the UE to indicate status of the registration of the UE. In addition, the method includes sending a session-initiation message to the home-network entity by the UE, to initiate the specific communication session. Further, the method includes routing the session-initiation message to a specific-session entity (122) attached with the home overlay network or the visitor overlay network.

### FIELD OF THE INVENTION

The present invention generally relates to the field of networks, and more specifically to a method and network architecture for establishing a specific communication session in a communication network.

### BACKGROUND OF THE INVENTION

An increased need for communication has led to the integration of communication networks, for example, telecommunication networks, the Internet and the like. For this integration, there are various overlay systems, for example, an Internet-protocol Multimedia System (IMS). The IMS defines architecture for implementing Voice over Internet Protocol (VoIP) and multimedia services in a communication network. The communication network includes one or more access networks linked with the IMS. Some examples of access networks include a Global System for Mobile Communications (GSM) network, a Wideband Code Division Multiple Access (WCDMA) network, a Code Division Multiple Access 2000 (CDMA2000) network, a Wireless Local Area Network (WLAN), a Universal Mobile Telecommunications System (UMTS) network, a Worldwide Interoperability for Microwave Access (Wi-Max) network, a Digital Subscriber Line (DSL) network, a Cable Network and a Plain Old Telephone System (POTS) network.

The communication network also includes several User Equipments (UEs) that interact with each other using the communication network. Examples of the UE include mobile phones, laptops, Personal Digital Assistants (PDAs) and the like. The IMS provides one or more services to a User Equipment (UE). Examples of the services include, establishing a specific communication session, Push-to-talk-Over-Cellular (POC), multiparty gaming, videoconferencing, messaging, and content sharing. Examples of the specific communication session include an emergency call, a high-priority call and the like.

In existing architecture of the overlay system, for initiating the specific communication session, the UE has to register for the specific communication session while initiating the specific communication session. The registration causes delays in establishing the specific communication session.

Especially when the UE is in a visitor overlay network the delays can be substantial. For example, in existing architecture of the IMS, during roaming of the UE, for initiating the emergency call, the UE must set up a connection through a Proxy Call Session Control Function (P-CSCF) of a visitor IMS network. The UE also needs to register through the P-CSCF of the visitor IMS network during establishing the emergency call. This registration causes delays while establishing the emergency call. In addition, the existing architecture of the IMS does not provide any implicit registration of the UE for the emergency call, during the registration of the UE with the IMS.

### BRIEF DESCRIPTION OF THE FIGURES

The present invention is illustrated by way of example, and not limitation, in the accompanying figures, where like reference numerals refer to identical or functionally similar elements throughout the separate views and which together with the detailed description below are incorporated, and in which:

FIG. 1 is a block diagram illustrating an exemplary communication network, in accordance with various embodiments of the present invention;

FIG. 2 is a flow diagram illustrating a method of establishing a specific communication session in a communication network, in accordance with one of the embodiment of the present invention;

FIG. 3 is a flow diagram illustrating a method of establishing an emergency call in a communication network, in accordance with one of the embodiment of the present invention;

FIG. 4 is a call flow diagram illustrating registration of a UE for a specific communication session in a communication network, in accordance with one of the embodiment of the present invention; and

FIG. 5 is a call flow diagram illustrating establishing of the specific communication session in a communication network, in accordance with one of the embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

An embodiment of the present invention provides a method of establishing a specific communication session between a User Equipment (UE) and a called entity in a communication network. The communication network includes a home overlay network and a visitor overlay network. The UE is associated with either a home access network or a visitor access network. The home access network is linked with the home overlay network and the visitor access network is linked with the visitor overlay network. The method includes registering the UE for the specific communication session through a home-network entity attached with the home overlay network. The registration for the specific communication session is done during registration of the UE with the home overlay network. Further, the UE sends a session initiation message to the home-network entity to initiate the specific communication session. In addition, the session initiation message is routed from the home-network entity to a specific-session entity. The specific-session entity is attached with either the home overlay network or the visitor overlay network.

Another embodiment of the present invention provides a network architecture for establishing a specific communication session between a User Equipment (UE) and a called entity. The network architecture includes a home overlay network and a visitor overlay network. A home-network entity is attached with the home overlay network. The home-network entity facilitates registration of the UE for the specific communication session, during registration of the UE with the home overlay network. The home-network entity receives a session initiation message from the UE for initiating the specific communication session. The UE is associated with either a home access network or a visitor access network. The home access network is linked with the home overlay network and the visitor access network is linked with the visitor overlay network. The network architecture also includes a specific-session entity. The specific-session entity receives the session initiation message from the home-network entity and routes the session initiation message to the called entity.

Before describing in detail the particular method and the network architecture for establishing the specific communication session between the User Equipment (UE) and the called entity in the communication network in accordance with various embodiments of the present invention, it should be observed that the present invention resides primarily in combinations of the method steps and the network architecture related to establishing the specific communication session between the UE and the called entity in the communication network. Accordingly, the method steps and the network architecture have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second and the like may be used solely to distinguish one entity or action from another entity or action without necessarily requiring or implying any actual such relationship or order between such entities or actions. The terms ‘comprises,’ ‘comprising,’ or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by ‘comprises . . . a’ does not, without more constraints, preclude the existence of additional identical elements in the process, method, article, or apparatus that comprises the element.

The term ‘another’, as used herein, is defined as at least a second or more. The terms ‘including’ and/or ‘having’, as used herein, are defined as comprising.

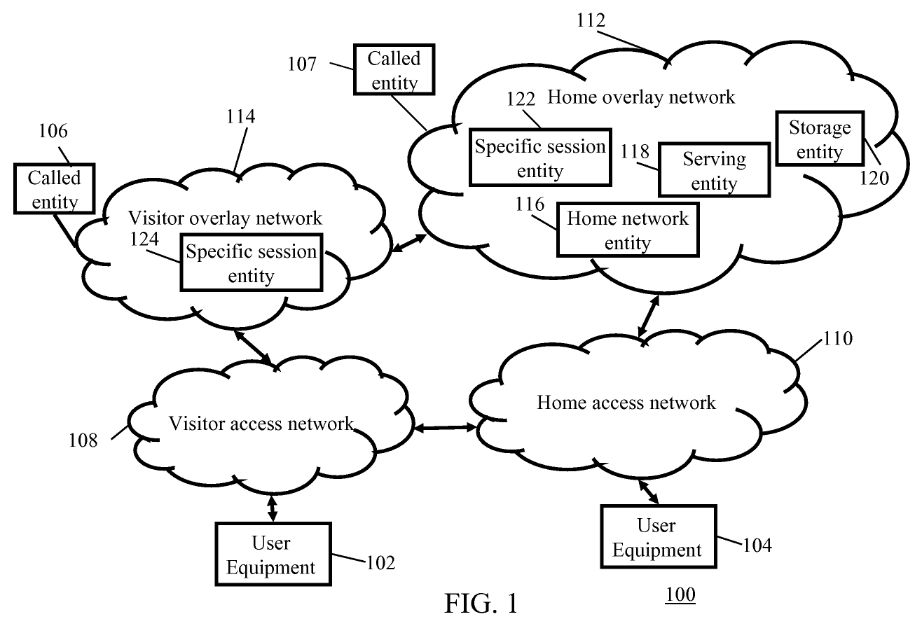

FIG. 1 is a block diagram illustrating an exemplary communication network 100, in accordance with various embodiments of the present invention. The communication network 100 can be geographically spread over a wide area, such as a city, a state, a country and so forth. The communication network 100 can be a combination of two or more networks, for example, a Local Area Network (LAN), a Metropolitan Area Network (MAN), a Wide Area Network (WAN), a telecommunication network, the Internet and the like. The communication network 100 includes a plurality of User Equipments (UEs), for example, a UE 102 and a UE 104. Examples of the UE include, but are not limited to, mobile phones, computers, laptops, Personal Digital Assistants (PDAs), and other mobile computational devices. The UEs interact with each other using the communication network 100. The communication network 100 further includes one or more called entities. For example, the communication network 100 is shown to include a called entity 106 and a called entity 107. Example of the called entity 106 includes, but is not limited to, a Public Service Answering Point (PSAP). Typically, the UE establishes an emergency call with the called entity.

Further, the communication network 100 includes a plurality of access networks, for example, a visitor access network 108 and a home access network 110. It should be noted that terms such as ‘home’ and ‘visitor’ are used to describe in reference to the location of the UE. For example, in communication network 100, the UE 104 is shown to be its home access network (the home access network 110). During roaming, when the UE 104 moves to any other access network, the other access network becomes a visitor access network for the UE 104. Examples of the visitor access network 108 and the home access network 110 include, but are not limited to, a General Packet Radio Service (GPRS) network, a Global System of Mobile Communication (GSM) network, a Wideband Code Division Multiple Access (WCDMA) network, a Code Division Multiple Access 2000 (CDMA2000) network, a Wireless Local Area Network (WLAN) network, a Universal Mobile Telecommunications System (UMTS) network, a Worldwide Interoperability for Microwave Access (Wi-Max) network, a Digital Subscriber Line (DSL) network, a Cable network and a Plain Old Telephone System (POTS) network. Each UE is associated with either the home access network or the visitor access network. In an embodiment, in communication network 100, the UE 102 is shown to be associated with the visitor access network 108 and the UE 104 is shown to be associated with the home access network 110.

The communication network 100 further includes overlay networks. An overlay network is a virtual network that is built on top of a plurality of access networks for providing services to the plurality of access networks. For example, the communication network 100 is shown to include a home overlay network 112 and a visitor overlay network 114. It should be noted that terms such as ‘home’ and ‘visitor’ are used to describe in reference to the location of the UE. For example, in communication network 100, the UE 104 is shown to be its home overlay network (the home overlay network 112). During roaming, when the UE 104 moves to any other overlay network, the other overlay network becomes a visitor access network for the UE 104.

The plurality of access networks are linked with an overlay network. For example, the home access network 110 is linked with the home overlay network 112 and the visitor access network 108 is linked with the visitor overlay network 114. The home access network 110 enables its associated UE, for example, the UE 104 to access the home overlay network 112 and the visitor access network 108 enables its associated UE, for example, the UE 102 to access the visitor overlay network 114. Similarly, the one or more called entities are associated with the overlay network. For example the called entity 106 is shown to be associated with the visitor overlay network 114 and the called entity 107 is shown to be associated with the home overlay network 112.

The home overlay network 112 includes a home-network entity 116, a serving entity 118, a storage entity 120, and the specific-session entity 122. The home-network entity 116 is the first point of contact for the UE in the home overlay network 112. The home-network entity facilitates registering of the UE for the specific communication session. The serving entity 118 registers and provides service to the UE. The services include but are not limited to routing and translation, providing billing information, maintaining session timers, and interrogating the storage entity 120 for retrieving authorization information. The storage entity 120 stores service data which include identity information of the UEs, roaming profile of the UEs and the like. The specific session entity locates the called entity for establishing the specific session. Typically, the specific-session entity is an Emergency Call Session Control Function (E-CSCF). In an embodiment, the home overlay network 112 and the visitor overlay network 114 are Internet-protocol Multimedia System (IMS) networks. Typically, in the IMS network, the home-network entity 116 is a Proxy Call Session Control Function (P-CSCF) that is extended to support the specific communication session. In an embodiment, the serving entity 118 is a Serving Call Session Control Function (S-CSCF) and the storage entity 120 is a Home Subscriber Server (HSS). The visitor overlay network also includes a specific-session entity. For example, the visitor overlay network includes a specific-session entity 124.

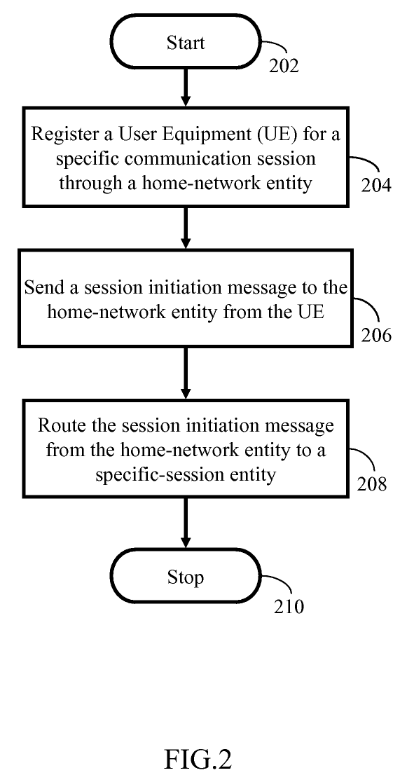

FIG. 2 is a flow diagram illustrating a method of establishing a specific communication session in the communication network 100, in accordance with one of the embodiment of the present invention. Typically, the specific communication session is an emergency call. At step 202 the method can begin. At step 204, the UE, for example, the UE 102 registers for the specific communication session through the home-network entity, for example, the home-network entity 116. The registration of the UE 102 for the specific communication session, through the home-network entity 116 is carried out during the registration of the UE 102 with the home overlay network 112. In an embodiment, registering the UE 102 for the specific communication session includes using a registration identifier of the registration of the UE 102 with the home overlay network 112. Typically, the UE 102 sends its location information to the home-network entity 116 for the registration for the specific communication session. In an embodiment, the home-network entity 116 determines, through a Domain Name Service (DNS) server lookup or through a lookup table, whether the specific-session entity 124 is accessible from the home-network entity 116.

In an embodiment, the home-network entity, for example, the home-network entity 116 sends an indication message to the UE, for example, the UE 102. The indication message indicates to the UE 102 the status of the registration for the specific communication session. Typically, the home-network entity 116 sends the indication message when it determines that the specific-session entity 124 is reachable. The indication message can be sent as a separate message or along with other messages. The indication message indicates by displaying, for example, a text message, an indication symbol, and the like, on a Graphical User Interface (GUI) of the UE 102. In an embodiment, the indication message indicates to the UE 102, that the UE 102 cannot be registered for the specific communication session. In an embodiment, after the registration of the UE 102 for the specific communication session, the UE 102 establishes a security association with the home-network entity 116. The security association provides an integrity protection between the UE 102 and the home-network entity 116.

At step 206, the UE, for example, the UE 102 sends a session initiation message to the home-network entity, for example, the home-network entity 116. Typically, the session-initiation message includes an address of the home-network entity 116, a location information of the UE 102, a registration identifier of the registration of the UE 102 with the home overlay network 112, an identifier for the visitor overlay network 114, and an address of the specific-session entity 124.

At step 208, the home-network entity, for example, the home-network entity 116 routes the session-initiation message to the specific-session entity, for example, the specific-session entity 124. In an embodiment, the home-network entity 116 determines the location of the specific-session entity 124 by a Domain Name Service (DNS) server lookup or a lookup table. Once the session initiation message is received, the specific-session entity 124 routes the session-initiation message to the called entity 106. Thereafter the method can terminate at step 210.

In an embodiment, the UE 104 is registered with the home-network entity 116 for the specific communication session during its registration with the home overlay network 112. After registering, the home-network entity 116 sends the indication message to the UE 104. The UE 104 sends a session-initiation message to the home-network entity 116. The home-network entity 116 routes the session initiation message to the specific-session entity 122. Typically, the home-network entity routes the session initiation message to the called entity 107.

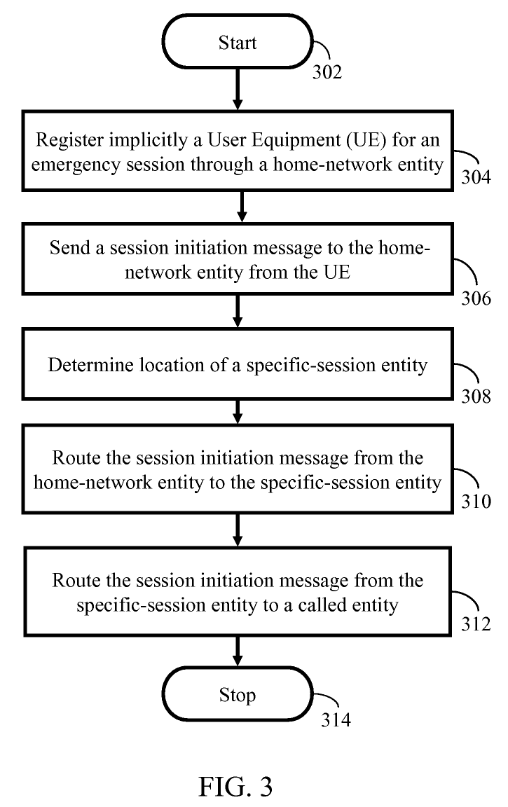

FIG. 3 is a flow diagram illustrating a method of establishing an emergency call in the communication network 100, in accordance with one of the embodiment of the present invention. At step 302, the method can begin. At step 304, the UE, for example, the UE 102 is registered implicitly for the emergency call through the home-network entity, for example, the home-network entity 116. The registration of the UE 102 for the emergency call, through the home-network entity 116 is performed during the registration of the UE 102 with the home overlay network 112. In an embodiment, registering the UE 102 for the emergency call includes using a registration identifier of the registration of the UE 102 with the home overlay network 112. Typically, the UE 102 sends the location information of the UE 102 to the home-network entity 116. In an embodiment, the location information of the UE 102 can be used for locating a visitor overlay network of the UE 102. In an embodiment, the home-network entity 116 determines whether the specific-session entity 124 is reachable from the home-network entity 116. In this embodiment, the home-network entity 116 determines whether the specific-session entity 124 is reachable from the home-network entity 116 through the DNS server lookup or through the lookup table. In an embodiment, when the home network entity determines that the UE can not be registered for the specific communication session with the home network entity, it continues with the registration of the UE with the home network entity.

In an embodiment, the home-network entity 116 also sends the indication message to the UE 102. The indication message indicates the status of the registration for the emergency call to the UE 102. Typically, the UE 102 sends the indication message when the home-network entity determines that the specific-session entity 124 is reachable and the visitor overlay network allows the UE 102 to register for the emergency call. The indication message is sent as a separate message or along with any other message. Typically, the indication message indicates to the UE 102 about the status of the registration for the specific communication session by displaying, for example, a text message, an indication symbol, and the like, on a Graphical User Interface (GUI) of the UE 102. In an embodiment, the indication message indicates to the UE 102 that it cannot be registered for the emergency call. In an embodiment, when the UE 102 does not receive an indication message, it can assume that the registration for the emergency call cannot be performed. In another embodiment, after the registration of the UE 102 for the emergency call, through the home-network entity 116, the UE 102 establishes a security association with the home-network entity 116. The security association provides integrity protection between the UE 102 and the home-network entity 116.

At step 306, the UE 102 sends a session-initiation message to the home-network entity 116. In an embodiment, when the UE detects a request for the emergency sessions, it determines whether it is registered for the emergency call. When the UE determines that it is not registered for the emergency call, it can follow the procedures as indicated in 3GPP TR 23.867 V1.2.0 (2005-09), titled 3rd Generation Partnership Project; Technical Specification Group Services and System Aspects; Internet Protocol (IP) based IP Multimedia Subsystem (IMS) emergency sessions; (Release 7). Typically, the session-initiation message includes the address of the home-network entity 116, the location information of the UE 102, the registration identifier of the registration of the UE 102 with the home overlay network 112, the identifier for the visitor overlay network 114, and the address of the specific-session entity 124. In an embodiment, the home-network entity 116 is a Proxy Call Session Control Function (P-CSCF) extended to support the emergency call.

At step 308, the home-network entity determines the location of the emergency call entity. For example, the home-network entity 116 determines the location of the specific-session entity 124. Typically, the home-network entity 116 determines the location of the emergency call entity using the DNS server lookup or the lookup table.

At step 310, the home-network entity, for example, the home-network entity 116 routes the session-initiation message to the specific-session entity, for example, the specific-session entity 124. In an embodiment, the specific-session entity is the Emergency Call Session Control Function (E-CSCF). At step 312, the specific-session entity, for example, the specific-session entity 124 routes the session-initiation message to the called entity, for example, the called entity 106. Typically, the called entity is the PSAP. Thereafter, the method can terminate at step 314.

In an embodiment, the UE 104 is registered with the home-network entity 116 for the specific communication session during its registration with the home overlay network 112. After registering, the home-network entity 116 sends the indication message to the UE 104. The UE 104 sends a session-initiation message to the home-network entity 116. The home-network entity 116 determines location of a specific-session entity 122. The home-network entity 116 routes the session initiation message to the specific-session entity 122. The home-network entity 116 then routes the session initiation message to the called entity 107.

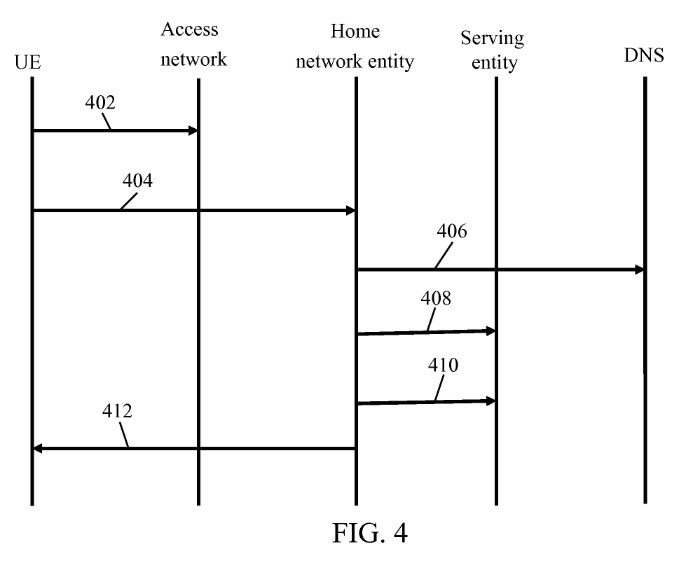

FIG. 4 is a call flow diagram illustrating registration of a UE for a specific communication session in a communication network 100, in accordance with one of the embodiment of the present invention. In an embodiment, the UE, for example, the UE 102 sends a message 402 to the access network, for example, the visitor access network 108. In an embodiment, for the UE 102, the home overlay network 112 is the home IMS network and the visitor access network 108 is the visitor GPRS network. In this embodiment, by sending the message 402, the UE 102 creates a Packet Data Protocol (PDP) context with a Gateway GPRS Support Node (GGSN). The GGSN is attached with the visitor GPRS network. Typically, the UE 102 performs a bearer registration and a resource request when the UE 102 initially powers on into the visitor access network 108. The bearer registration enables the UE 102 to use the visitor access network 108. The resource request is a request for resources such as bandwidth and the like. Typically, when the visitor-access network is the visitor GPRS network, the bearer registration is a Packet Switched (PS)-attach procedure and the resource request is the PDP activation procedure. In an embodiment, an Internet Protocol (IP) address can be assigned to the UE 102. In an embodiment, when the UE, for example, the UE 102 is equipped with a Universal Integrated Circuit Card (UICC), it initiates an IMS registration by sending a registration message to the home network entity, for example, the home-network entity 116.

After creating the PDP context, the UE, for example, the UE 102 sends a message 404 to the home-network entity, for example, the home-network entity 116. The message 404 registers the UE 102 for the specific communication session. In an embodiment, the message 404 includes a public UE identity, a private UE identity, a domain name of the home access network 110, an IP address of the home access network 110, and an identifier of the visitor overlay network 114.

In an embodiment, the home-network entity 116 determines whether the UE 102 can be registered for the specific communication session. Typically, the home-network entity 116 sends a message 406 to the DNS server. The message 406 includes the identifier of the visitor overlay network 114. The message 406 enables the home-network entity 116 to determine whether the visitor access network 108 allows the UE 102 to initiate the specific communication session without a special registration identifier. In an embodiment, information about whether the visitor access network 108 allows the UE to initiate the specific communication session without a special registration identifier can be stored in a database, for the home-network entity 116. Typically, the specific-session entity 124 is the E-CSCF.

In an embodiment, after determining that the UE, for example, the UE 102 can be registered for the specific communication session, the home-network entity, for example, the home-network entity 116 sends a message 408 to a serving entity, for example the serving entity 118. The message 408 initiates an authentication and authorization process. Typically, the serving entity 118 is the Serving Call Session Control Function (S-CSCF). The serving entity 118 also registers the UE 102 with the home overlay network 112.

In an embodiment, when the home-network entity 116 determines that the UE 102 can be registered for the specific communication session, it sends a message 410, to the serving entity 118. The message 410 indicates to the serving entity 118 that the UE 102 can be registered for the specific communication session. The serving entity 118 registers the UE 102 with the home overlay network 112. Typically, the serving entity 118 registers the UE 102 with the home overlay network 112 for the specific communication session. In an embodiment, the serving entity 118 registers an emergency Session Initiation Protocol-Uniform Resource Identifier (SIP-URI) of the UE 102. The home-network entity 116 sends the SIP-URI included in a Private-associated Uniform Resource Identifier (P-associated URI) field.

Once the authentication and the authorization are complete, the home-network entity, for example, the home-network entity 116 sends an indication message 412 to the UE, for example, the UE 102. The indication message 412 indicates the status of the registration for the specific communication session to the UE 102. Typically, when the serving entity 118 provides an indication that the UE 102 is registered for the specific communication session, the P-associated URI includes the emergency SIP-URI of the UE 102. On receiving the emergency SIP-URI included in the indication message, the UE 102 gets the indication that it is registered for the specific communication session. In an embodiment, an association between the UE 102 and home-network entity 116 is created during the registration for the specific communication session.

In an embodiment, the indication message 412 includes a Session Initiation Protocol (SIP) message. Typically, the SIP message includes a message that informs the UE 102 that the UE 102 is registered for the specific communication session. In another embodiment, the home-network entity sends a SIP NOTIFY message to the UE 102. In yet another embodiment, the home-network entity sends a SIP INFO message to the UE 102 informing that it is registered for the specific communication session.

In an embodiment, the UE, for example, the UE 104 sends the message 402 to the access network, for example, the home access network 110. In an embodiment, for the UE 104, the home overlay network 112 is the home IMS network and the home access network 110 is the home GPRS network. In this embodiment, the UE 104 sends the message 402 to create a PDP context with a GGSN. The GGSN is attached with the home GPRS network. Typically, the UE 104 performs a bearer registration and a resource request when it initially powers on into the home access network 110. The UE 104 sends the message 404 to the home-network entity, for example, the home-network entity 116. The message 404 registers the UE 104 for the specific communication session.

In an embodiment, the home-network entity 116 locates a specific-session entity 122. Typically, the specific-session entity 122 is the E-CSCF. The home-network entity 116 also determines whether the home access network 110 allows the UE 104 to initiate the specific communication session without the special registration identifier.

In an embodiment, after determining that the UE, for example, the UE 104 can be registered for the specific communication session, the home-network entity, for example, the home-network entity 116 sends the message 408 to a serving entity, for example, the serving entity 118. The message 408 initiates an authentication and authorization process. Typically, the serving entity 118 is the Serving Call Session Control Function (S-CSCF). The serving entity 118 also registers the UE 104 with the home overlay network 112.

In an embodiment, when the home-network entity 116 determines that the UE 104 can be registered for the specific communication session, it sends the message 410, to the serving entity 118. The message 410 indicates to the serving entity 118 that the UE 104 can be registered for the specific communication session. The serving entity 118 registers the UE 104 with the home overlay network 112. Typically, the serving entity 118 registers the UE 104 with the home overlay network 112 for the specific communication session.

Once the authentication and the authorization are complete, the home-network entity, for example, the home-network entity 116 sends the indication message 412 to the UE, for example, the UE 104. The indication message 412 indicates the status of the registration for the specific communication session to the UE 102.

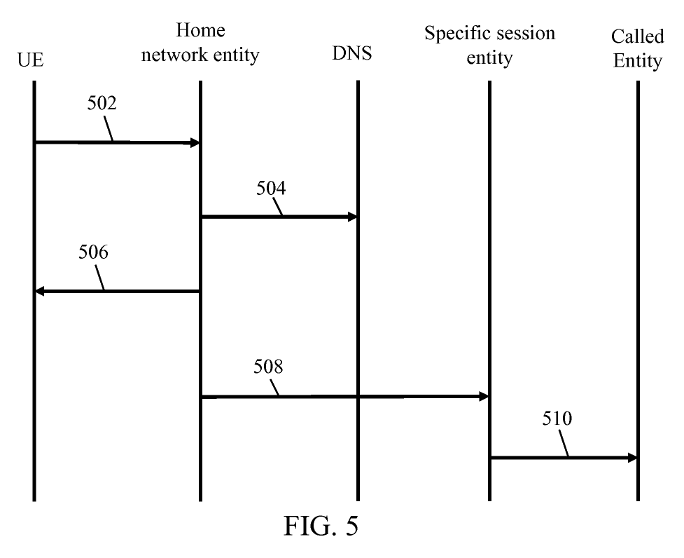

FIG. 5 is a call flow diagram illustrating establishing of the specific communication session in a communication network 100, in accordance with one of the embodiment of the present invention. The UE, for example, the UE 102 sends a session initiation message 502 to the home-network entity, for example, the home-network entity 116, to initiate the specific communication session. Typically, the specific communication session is the emergency call. In an embodiment, the session initiation message 502 is a SIP INVITE message. Typically, the UE 102 sends the SIP INVITE using the address of the home-network entity 116 and an emergency security association obtained during the registration for the specific communication session. Typically, the SIP INVITE message includes the identifier of the visitor overlay network 114 in its P-Visited-Network-ID header. The P-Visited-Network-ID header also includes a Public Land Mobile Network Identifier (PLMN-ID) of the visitor overlay network 114. In an embodiment, when the visitor access network 108 is either a GSM or a GPRS network, the PLMN-ID includes a Mobile Country Code (MCC) and a Mobile Network Code (MNC) of the visitor access network 108. In this embodiment, the PLMN-ID can also include a Cell Global ID (CGI) in a P-Access-Network-Info field. Typically, the SIP INVITE message also includes an emergency session indication.

In an embodiment, on receiving the session-initiation message from the UE, for example, the UE 102, the home-network entity, for example, the home-network entity 116 determines that whether the session initiation message is for initiating the specific communication session. Typically, the home-network entity 116 determines that the SIP INVITE is for the emergency session through an emergency indication in the SIP INVITE message.

In an embodiment, the home-network entity, for example, the home-network entity 116 performs a DNS look-up 504 to determine the location of the visitor overlay network, for example, the visitor overlay network 114. In another embodiment, the UE 102 sends the identifier of the visitor overlay network 114 along with the message 404 to the home-network entity 116. Typically, the home-network entity 116 uses the identifier of the visitor overlay network 114 to perform a pro-active DNS query, to find the specific-session entity 124 in the visitor overlay network 114.

In an embodiment, a message 506 enables the home-network entity, for example, the home-network entity 116 to modify existing bearer resources to ensure required Quality of Service (QoS) for the specific communication session. In an embodiment, when the visitor access network 108 is the visitor GPRS network, the home-network entity 116 sends a signal to a Policy and Charging Rules Function (PCRF). The PCRF signals the GGSN for modifying the PDP context to a higher priority for the specific communication session. In an embodiment, a secondary PDP context with the required QoS can be established. Typically, the modification can be initiated by the UE 102, by sending a signal in the visitor access network 108. In an embodiment, the home-network entity, for example, the home-network entity 116 also sends a session-initiation message 508 for the specific communication session to the specific-session entity 124.

By sending a message 510, the specific-session entity, for example, the specific-session entity 124 routes the session-initiation message to the called entity, for example, the called entity 106. Typically, the specific-session entity 124 determines the location of the called entity 106 and routes the session initiation message to the called entity 106. Thereafter, the emergency call is set up between the called entity 106 and the UE 102.

In an embodiment of the invention, the UE, for example, the UE 104 sends the session initiation message 502 to the home-network entity, for example, the home-network entity 116, to initiate the specific communication session. Typically, the specific communication session is the emergency call. In an embodiment, the session initiation message 502 is a SIP INVITE message.

In an embodiment, on receiving the session initiation message 502 from the UE, for example, the UE 104, the home-network entity, for example, the home-network entity 116, determines that whether the session initiation message is for initiating the specific communication session.

In an embodiment, the message 506 enables the home-network entity, for example, the home-network entity 116 to modify existing bearer resources to ensure required Quality of Service (QoS) for the specific communication session. In an embodiment, the home-network entity, for example, the home-network entity 116 sends the session-initiation message 508 for the specific communication session to the specific-session entity 122.

By sending the message 510, the specific-session entity, for example, the specific-session entity 122, routes the session initiation message to the called entity, for example, the called entity 107. Typically, the specific-session entity 122 determines the location of the called entity 107 and routes the session initiation message to the called entity 107. Thereafter, the specific communication session is set up between the UE 104 and the called entity 107.

Therefore, as described above, the present invention provides a method and network architecture for establishing a specific communication session, for example, an emergency call between a UE and a called entity in a communication network. The UE is registered for the specific communication session, by a home-network entity, for example, the P-CSCF of the home overlay network, during the registration of the UE with the home overlay system. The UE uses the home-network entity for establishing the specific communication session. This results in a simplification of the network architecture and a significant reduction in set up time for the specific communication session. The home network entity also sends an indication message indicating status of the registration of the UE for the specific communication session. In an embodiment, in an IMS network, the UE can establish the emergency call without setting up a new PDP context. Further, the UE can establish an emergency call without needing a pre-specified per user emergency public user identity. The network architecture can also be extended for Internet Protocol-Controller Area Networks (IP-CANs) that do not support the Access Point Name (APN) concept as well.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the present invention and its benefits and advantages have been described with reference to specific embodiments. However, one of ordinary skill in the art appreciates that various modifications and changes can be made without departing from the scope of the present invention, as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution, to occur or become more pronounced, are not to be construed as critical, required or essential features, or elements of any or all the claims. The present invention is defined solely by the appended claims including any amendments made during the pendency of this application and all equivalents of those claims as issued.

What is claimed is:

1. A method of establishing a specific communication session between a user equipment (UE) and a called entity in a communication network, wherein the communication network comprises a home overlay network and a visitor overlay network, the method comprising:
registering the UE for the specific communication session through a home-network entity during registration of the UE with the home overlay network, the home-network entity being attached with the home overlay network, wherein the UE is associated with one of a home access network and a visitor access network, the home access network being linked with the home overlay network, the visitor access network being linked with the visitor overlay network;
sending a session initiation message to the home-network entity from the UE to initiate the specific communication session; and
routing the session initiation message from the home-network entity to a specific-session entity attached with one of the home overlay network and the visitor overlay network.

2. The method as recited in claim 1, wherein the method further comprises sending an indication message to the UE from the home-network entity, wherein the indication message indicates status of the registration of the UE for the specific communication session.

3. The method as recited in claim 1, wherein the method further comprises routing the session initiation message from the specific-session entity to the called entity.

4. The method as recited in claim 1, wherein the home overlay network is a home Internet protocol Multimedia System (IMS) network and the visitor overlay network is a visitor IMS network.

5. The method as recited in claim 1, wherein the specific communication session is an emergency call.

6. A network architecture for establishing a specific communication session between a user equipment (UE) and a called entity, wherein the network architecture comprises a home overlay network and a visitor overlay network, the network architecture comprising:
a home-network entity attached with the home overlay network, the home-network entity facilitating registration of the UE for the specific communication session during registration of the UE with the home overlay network, the home-network entity further receiving a session initiation message from the UE for initiating the specific communication session, wherein the UE is associated with one of a home access network and a visitor access network, the home access network being linked with the home overlay network and the visitor access network being linked with the visitor overlay network; and
a specific-session entity for receiving the session initiation message from the home-network entity and routing the session initiation message to the called entity.

7. The network architecture as recited in claim 6, wherein the home-network entity is a Proxy Call Session Control Function (P-CSCF) extended to support the specific communication session.

8. The network architecture as recited in claim 6, wherein the specific-session entity is an Emergency Call Session Control Function (E-CSCF).

9. The network architecture as recited in claim 6, wherein the specific communication session is an emergency call.

10. The network architecture as recited in claim 6, wherein the session initiation message comprises one or more of an address of the home-network entity, location information of the UE, a registration identifier of the registration of the UE with the home overlay network, and an identifier for the visitor overlay network, and an address of the specific-session entity.
